(19) United States
(12) Patent Application Publication
(10) Pub. No.: US 2023/0298261 A1
(43) Pub. Date: Sep. 21, 2023

(54) DISTRIBUTED VISIBILITY STREAM GENERATION FOR COARSE GRAIN BINNING

(71) Applicant: Advanced Micro Devices, Inc., Santa Clara, CA (US)

(72) Inventors: Michael John Livesley, Milton Keynes (GB); Ruijin Wu, San Diego, CA (US); Mangesh P. Nijasure, Orlando, FL (US)

(73) Assignee: Advanced Micro Devices, Inc., Santa Clara, CA (US)

(21) Appl. No.: 17/845,890

(22) Filed: Jun. 21, 2022

Related U.S. Application Data
(60) Provisional application No. 63/322,077, filed on Mar. 21, 2022.

(51) Int. Cl. G06T 15/40; G06T 15/00; G06T 17/10; G06F 7/24

(52) U.S. Cl. CPC G06T 15/40; G06F 7/24; G06T 15/005; G06T 17/10

(57) ABSTRACT

Techniques for performing rendering operations are disclosed herein. The techniques include performing two-level primitive batch binning in parallel across multiple rendering engines, wherein tiles for subdividing coarse-level work across the rendering engines have the same size as tiles for performing coarse binning.

### CROSS-REFERENCE TO RELATED APPLICATIONS

This application claims the benefit of U.S. Provisional application No. 63/322,077, entitled “DISTRIBUTED VISIBILITY STREAM GENERATION FOR COARSE GRAIN BINNING,” filed on Mar. 21, 2022, the entirety of which is hereby incorporated herein by reference.

### BACKGROUND

Hardware-accelerated three-dimensional graphics processing is a technology that has been developed for decades. In general, this technology identifies colors for screen pixels to display geometry specified in a three-dimensional coordinate space. Improvements in graphics processing technologies are constantly being made.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 illustrates details of the device of FIG. 1, according to an example;

FIG. 3 is a block diagram showing additional details of the graphics processing pipeline illustrated in FIG. 2;

FIG. 4 illustrates additional details for the graphics processing pipeline;

FIG. 5 illustrates screen subdivisions for binning operations;

FIG. 6 illustrates parallel rendering operations;

FIG. 7 illustrates sub-divisions for parallel rendering; and

FIG. 8 is a flow diagram of a method for performing rendering operations, according to an example.

### DETAILED DESCRIPTION

Techniques for performing rendering operations are disclosed herein. The techniques include performing two-level primitive batch binning in parallel across multiple rendering engines, wherein tiles for subdividing coarse-level work across the rendering engines have the same size as tiles for performing coarse binning.

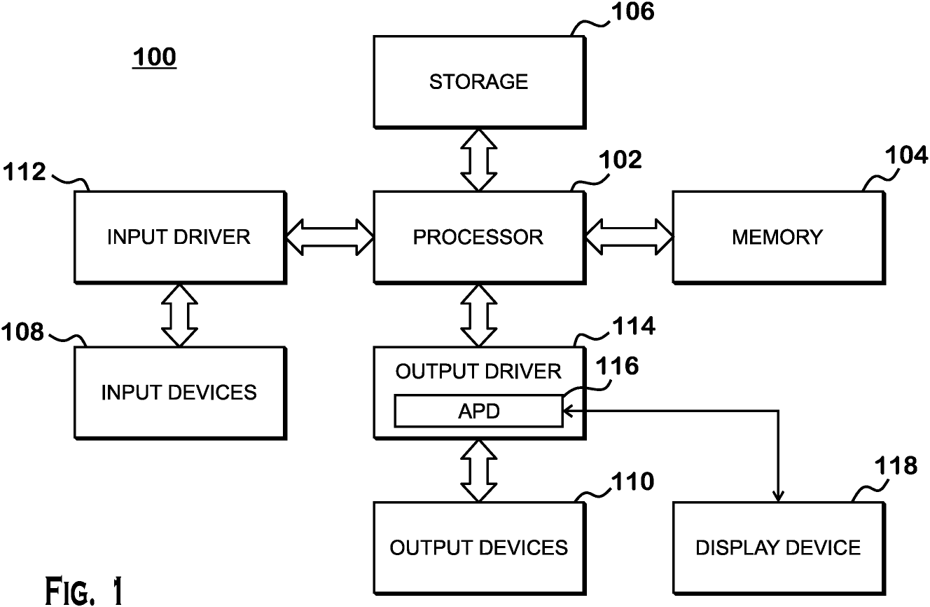

FIG. 1 is a block diagram of an example device 100 in which one or more features of the disclosure can be implemented. The device 100 could be one of, but is not limited to, for example, a computer, a gaming device, a handheld device, a set-top box, a television, a mobile phone, a tablet computer, or other computing device. The device 100 includes a processor 102, a memory 104, a storage 106, one or more input devices 108, and one or more output devices 110. The device 100 also includes one or more input drivers 112 and one or more output drivers 114. Any of the input drivers 112 are embodied as hardware, a combination of hardware and software, or software, and serve the purpose of controlling input devices 112 (e.g., controlling operation, receiving inputs from, and providing data to input drivers 112). Similarly, any of the output drivers 114 are embodied as hardware, a combination of hardware and software, or software, and serve the purpose of controlling output devices 114 (e.g., controlling operation, receiving inputs from, and providing data to output drivers 114). It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, without limitation, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 and output driver 114 include one or more hardware, software, and/or firmware components that are configured to interface with and drive input devices 108 and output devices 110, respectively. The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. The output driver 114 includes an accelerated processing device (“APD”) 116 which is coupled to a display device 118, which, in some examples, is a physical display device or a simulated device that uses a remote display protocol to show output. The APD 116 is configured to accept compute commands and graphics rendering commands from processor 102, to process those compute and graphics rendering commands, and to provide pixel output to display device 118 for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and configured to provide graphical output to a display device 118. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm performs the functionality described herein.

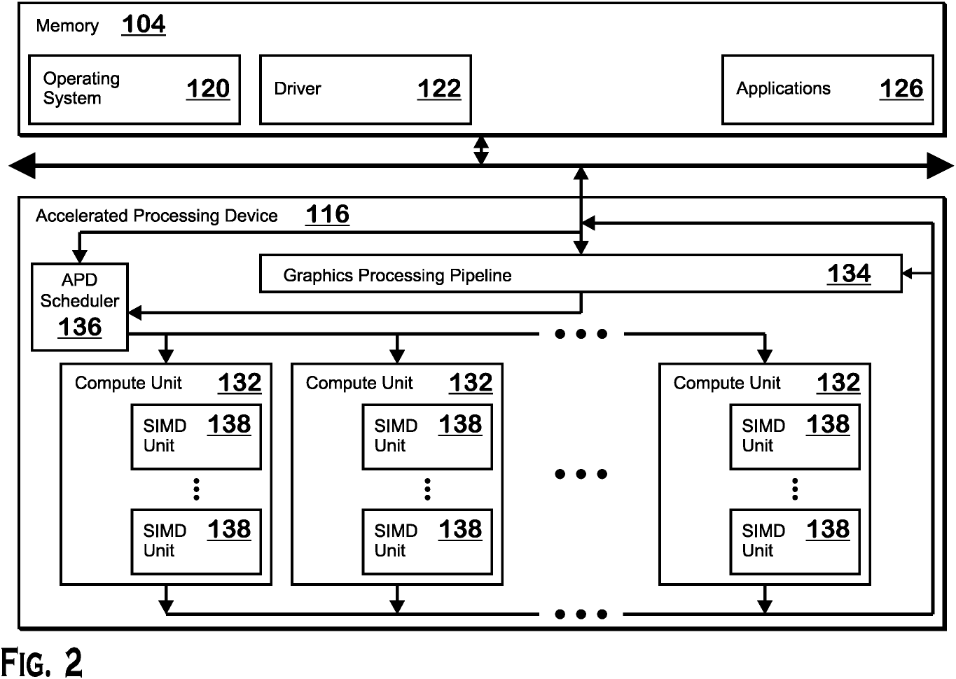

FIG. 2 illustrates details of the device 100 and the APD 116, according to an example. The processor 102 (FIG. 1) executes an operating system 120, a driver 122 (“APD driver 122”), and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. An APD scheduler 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

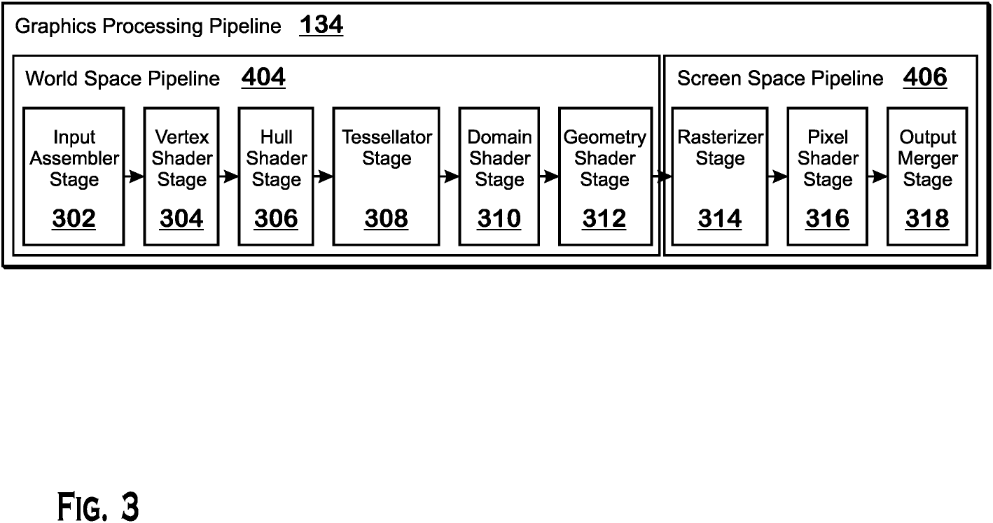

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are prewritten by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

The graphics processing pipeline 134 is divided into a world-space pipeline 404 and a screen-space pipeline 406. The world-space pipeline 404 converts geometry in world-space into triangles in screen space. The world-space pipeline 404 includes at least the vertex shader stage 304 (which transforms the coordinates of triangles from world-space coordinates to screen-space coordinates plus depth). In some examples, the world-space pipeline 404 also includes one or more of the input assembler stage 302, the hull shader stage 306, the tessellator stage 308, the domain shader stage 310, and the geometry shader stage 312. In some examples, the world-space pipeline 404 also includes one or more other elements not illustrated or described herein. The screen-space pipeline 406 generates colors for pixels of a render target (e.g., a screen buffer for display on a screen) based on the triangles in screen space. The screen-space pipeline 406 includes at least the rasterizer stage 314, the pixel shader stage 316, and the output merger stage 318, and also, in some implementations, includes one or more other elements not illustrated or described herein.

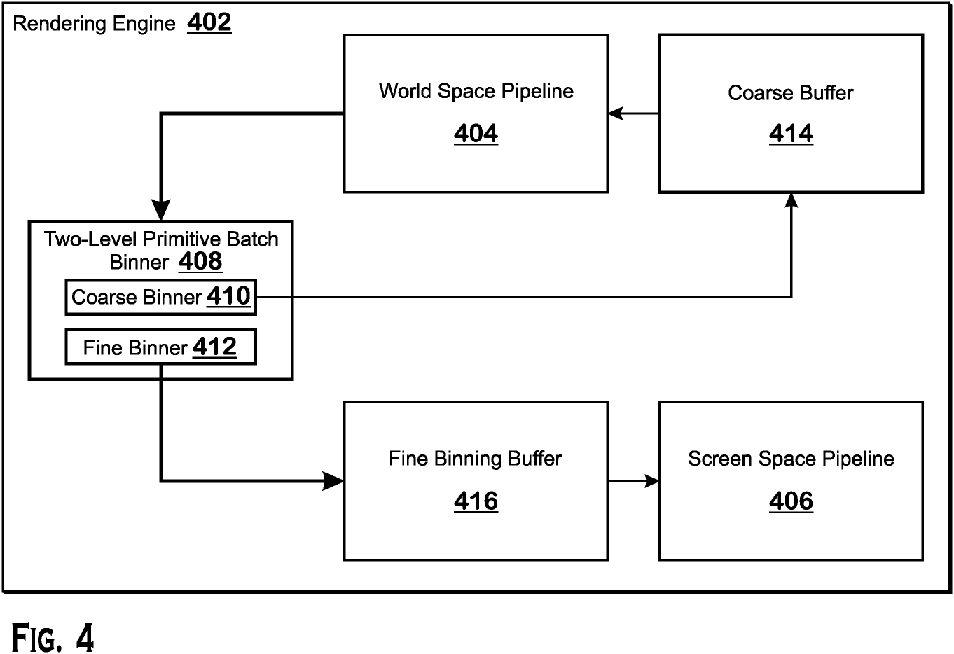

FIG. 4 illustrates a rendering engine 402 that includes a two-level primitive batch binner 408. The two-level primitive batch binner 408 performs binning on two levels: a coarse level and a fine level. In general, binning means collecting geometry information into a buffer and “replaying” that information in tile order. For coarse binning, ordering is performed with respect to coarse tiles and for fine binning, ordering is performed with respect to fine tiles. Replaying that information in tile order means sending the information in the buffer that overlaps a first tile to a portion of the rendering engine 402 for rendering, then sending the information in the buffer that overlaps a second tile to the portion for rendering, and so on. Binning in this manner gains benefits related to temporal and spatial cache locality. More specifically, by “reordering” work to be rendered on a tile-by-tile basis, work that is close together will be performed together, meaning that accesses to memory close together will be performed close together in time, which increases the likelihood that information fetched into a cache for the rendering engine 402 will be reused before being evicted, which reduces the overall number of misses, improves performance, reduces bandwidth in accesses to external memory, and reduces power consumption as a result. In various examples, the amount of work that is collected into the buffer is dependent on the size of the buffer, the type of work that is collected into the buffer, and the timing (e.g., relative to the frame or other timing aspect) of the work collected into the buffer. In some examples, the buffer collects geometry until the buffer is full and then replays the contents of the buffer. In some examples, the buffer replays the contents of the buffer after a different event occurs, such as the frame ending, or receiving an explicit indication to replay the contents of the buffer.

In general, two-level binning occurs in the following manner. A coarse binner 410 orders geometry output from the world space pipeline 404 into coarse bins. Each coarse bin includes geometry that overlaps a portion of screen space associated with that coarse bin. The coarse bins are larger than the fine bins for which fine binning occurs. The geometry overlapping the coarse bins is stored in the coarse buffer 414. The coarse buffer 414 replays the geometry to the world-space pipeline 404 in coarse bin order. The fine binner 412 stores the geometry into fine bins in the fine binning buffer 416. The fine binning buffer 416 then replays the fine bins in fine bin order. The fine bins are smaller than the coarse bins.

Because the coordinates of geometry are in world space at the beginning of the world-space pipeline 404, the first level includes processing the geometry through the world-space pipeline 404 to convert such geometry into screen space. Note that in this first level, the geometry does not proceed to the screen-space pipeline 406, since the purpose of coarse binning is to increase the locality of geometry fed to the second level of binning (the fine binning). In some examples, in addition to storing, into the coarse buffer 414, information regarding which coarse bins the geometry falls within, the coarse binner 410 also stores geometry into the coarse buffer 414 in a manner that indicates or is associated with visibility testing performed in the world space pipeline 404. More specifically, the world-space pipeline 404 performs certain tests to determine whether geometry is visible. Such tests include backface culling, which removes triangles whose back face is facing the camera (and is thus invisible), and, optionally, other forms of culling. The coarse binner 410 does not store geometry into the coarse buffer 414 if that geometry is determined to be culled by the world-space pipeline 404 in the coarse binning pass. In addition, the world-space pipeline 404 performs clipping. Clipping clips portions of geometry that fall outside of the viewport. In some examples, for triangles that are clipped, the world-space pipeline 404 converts such triangles into new triangles that occupy the space of the clipped triangle.

In sum, the coarse binner 410 performs coarse binning that includes at least two operations: the coarse binner 410 categorizes geometry processed through the world-space pipeline 404 as overlapping one or more individual coarse bins; and the coarse binner 410 stores the geometry in a way that indicates visibility information. Stated differently, in addition to organizing the coarse tiles, the coarse binner 410 may also store data indicating which triangles are culled (e.g., by culling operations of the world space pipeline 404 such as frustum culling, back-face culling, or other culling operations). The coarse binner 410 may store the sorted geometry in the coarse buffer 414 as draw calls or as compressed data that represents the geometry of a draw call, including whether the primitives in that geometry is culled. A draw call is an input to the rendering engine 402 that provides geometry such as vertices and requests rendering of that geometry. The term “call” refers to the fact that a draw call is a function in a graphics application programming interface (“API”) made available to software, such as software executing on a central processing unit.

The purpose of the coarse level of binning is to enhance the ability of the fine binning operations to group together geometry. More specifically, when a coarse tile is being replayed, the coarse level tile restricts geometry sent to the fine binner 412 to a coarse tile, which increases the amount of geometry in any particular fine binning tile. By including geometry restricted to a particular area of the render target (a coarse tile), fewer fine tiles will be involved in the fine binning operations, and more geometry will be within those fine tiles. This increased “crowding” improves the benefits obtained through fine binning, since more data is involved in the cache locality enhancements of fine binning.

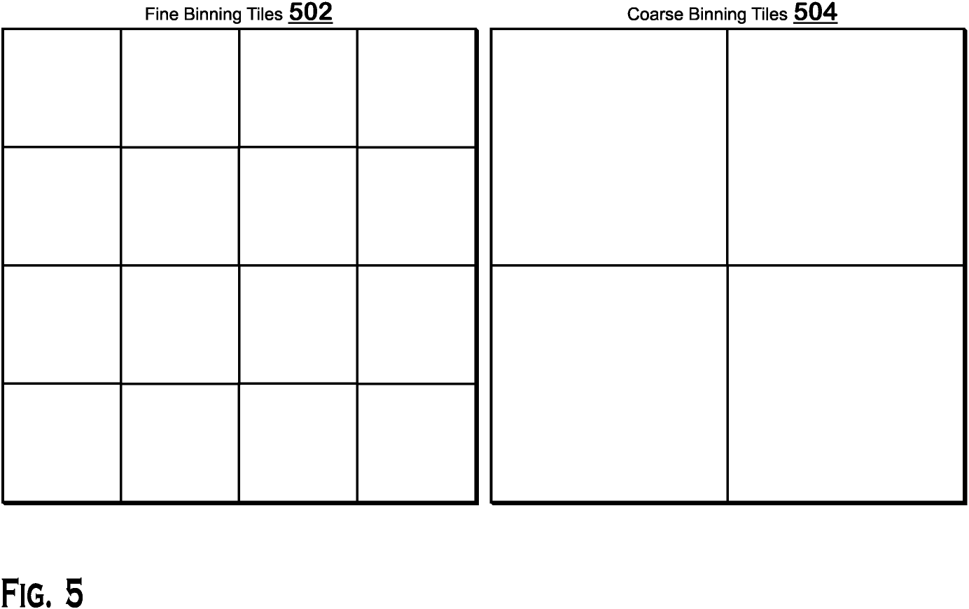

FIG. 5 illustrates fine binning tiles 502 and coarse binning tiles 504. The fine binning tiles 502 illustrate the size of the tiles that the fine binner 412 organizes geometry into. The coarse binning tiles 504 illustrate the size of the tiles that the coarse binner 410 organizes geometry into. The coarse binning tiles 504 are larger than the fine binning tiles 502.

More specifically, the coarse binning tiles 504 represent the portions of the render target that the coarse binner 410 organizes geometry into. As stated above, the coarse binner 410 sorts geometry based on which coarse tile the geometry overlaps. The coarse binning tiles 504 are the tiles upon which this sorting is based.

Similarly, the fine binning tiles 502 are the portions of the render target that the fine binner 412 organizes geometry into. The fine binner 412 sorts incoming geometry based on which fine binning tile 502 the geometry overlaps with.

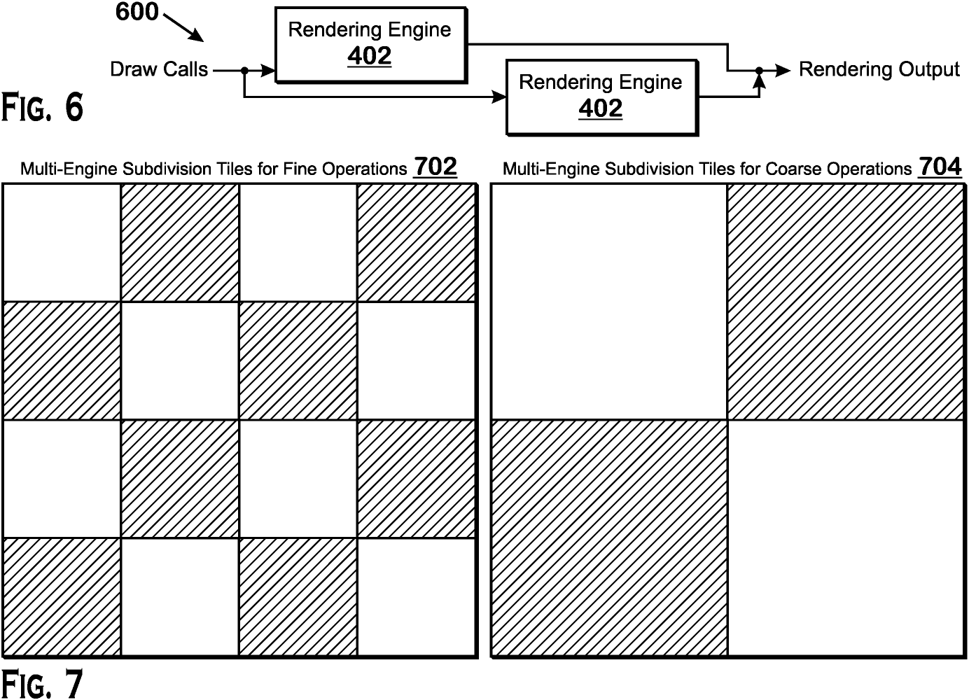

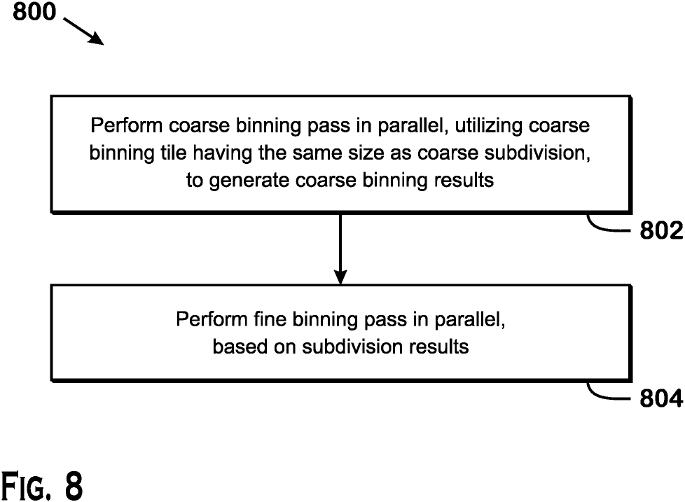

FIG. 6 and FIG. 7 will now be discussed together. FIG. 6 illustrates a parallel rendering system 600, according to an example. FIG. 7 illustrates subdivisions of a render target according to an example. The parallel rendering system 600 includes multiple rendering engines 402. The render target is divided into multi-engine subdivision tiles for fine operations 702 and multi-engine subdivision tiles for coarse operations 704. The multi-engine subdivision tiles for fine operations 702 are sometimes referred to herein as “fine subdivisions 702” and the multi-engine subdivision tiles for coarse operations 704 are sometimes referred to herein as “coarse subdivisions 704.”

These rendering engines 402 operate in parallel by operating on parallel rendering tiles of the render target. The rendering engines 402 generate data for different sets of parallel rendering tiles on different rendering engines 402. More specifically, each rendering engine 402 is assigned a different set of tiles. Each rendering engine 402 operates on the set of tiles assigned to that rendering engine 402 and not on tiles assigned to other rendering engines 402.

The manner in which data is subdivided between multiple parallel rendering engines 402 is different for the coarse binning operations as compared with the screen-space pipeline operations. More specifically, the geometry data is subdivided according to coarse subdivisions 704 for the coarse binning operations and the geometry data is subdivided according to fine subdivisions 702 for the screen-space operations.

Subdividing the geometry according to subdivisions means that one rendering engine 402 performs operations for one set of subdivisions and another rendering engine 402 performs operations for a different set of subdivisions. In the example illustrated, the top rendering engine 402 performs operations for the solid, un-shaded subdivisions and the bottom rendering engine 402 performs operations for the diagonally shaded subdivisions. Regarding coarse binning operations, each rendering engine of a plurality of rendering engines 402 performs coarse binning operations for the multi-engine subdivision tiles for coarse operations 704 that are assigned to that rendering engine 402 and not for the multi-engine subdivision tiles for coarse operations 704 that are assigned to any other rendering engine 402. Regarding fine binning operations, each rendering engine 402 of a plurality of rendering engines 402 performs fine binning operations for the multi-engine subdivision tiles for fine operations 702 assigned to that rendering engine 402 but not for the multi-engine subdivision tiles for fine operations 702 assigned to other rendering engines 402.

A rendering engine 402 performing operations according to a coarse subdivision means that, for the subdivisions assigned to a particular rendering engine 402, that rendering engine 402 determines which geometry in the world-space pipeline overlaps the coarse binning tiles 504 assigned to that rasterization engine 402. In other words, each rendering engine 402 operates on geometry that overlaps the coarse subdivision tiles 704 and determines which coarse binning tiles 504 such geometry overlaps. In addition, in implementations where the coarse binners 410 record information indicating which primitives are culled or clipped into the coarse buffer 414, each rendering engine 402 records that information for the primitives that overlap the coarse binning subdivisions 704 assigned to that rendering engine 402. Recording such information means recording “implicit” culling information, “explicit” culling information, or a combination of implicit and explicit culling information. Explicit culling information is recorded data that indicates which primitives are culled or clipped and how the primitives are clipped. Implicit culling information means information that is not explicitly indicated but that nonetheless indicates what is culled or clipped. In an example, primitives that were processed in the coarse binning operations (e.g., processing through the world-space pipeline 404 and coarse binner 410) and are determined to be culled are not included in the coarse buffer 414. Similarly, primitives that were determined to be clipped in the coarse binning operations are included as clipped primitives. The operations performed for coarse binning are sometimes referred to herein as a “coarse binning pass.”

Note that when the rendering engines 402 first receive primitives for the coarse binning operations, the rendering engines 402 may not know which coarse subdivision 704 each primitive overlaps. Thus, in some implementations, the rendering engines 402 process all received primitives through the world-space pipeline 404, which transforms the primitive coordinates into screen space. After this occurs, the coarse binner 410 of a rendering engine 402 stores primitives into the coarse buffer 414 that overlap the coarse subdivision 704 associated with that rendering engine 402, does not store primitives into the coarse buffer 414 that do not overlap any coarse subdivision 704 associated with that rendering engine 402. Thus, after the coarse binning operation, a rendering engine 402 stores primitives that overlap the coarse subdivisions 704 assigned to that rendering engine 402 but does not store primitives that do not overlap any coarse subdivision 704 assigned to that rendering engine 402.

With the primitives stored in the coarse buffer 414, the coarse binner 410 transmits those primitives to the world space pipeline 404 in a second pass, in which fine binning operations occur (a “fine binning pass”). In the fine binning pass, the world space pipeline 404 processes the received geometry normally, the fine binner 412 transmits the primitives in fine binning tile order to the screen-space pipeline 406, and the screen-space pipeline 406 processes the received geometry.

A rendering engine 402 performing operations for multi-engine subdivision tiles for fine operations 702 in the following manner. Each rendering engine 402 is assigned a particular set of multi-engine subdivision tiles for fine operations 702 (“fine subdivisions 702”). The fine binner 412 for each rendering engine 402 thus operations on geometry received from the world space pipeline 404 that overlaps the associated subdivisions 702 and does not perform operations on geometry received from the world space pipeline 404 that does not overlap the associated subdivisions 702. Note that it is possible for the coarse subdivisions 704 to have different sizes than the fine subdivisions 702. Thus, it is possible that a rendering engine 402 performs coarse binning operations for geometry that does not overlap the fine subdivisions 702 associated with that rendering engine 402. In that situation, in the fine binning pass, the rendering engine 402 does not process that geometry in the screen space pipeline 406. However, in the fine binning pass, for a rendering engine 402, the fine binner 412 and screen-space pipeline 406 do operate on geometry that overlaps the fine subdivisions associated with that rendering engine 402. Thus, a rendering engine 402 performs fine binning operations and screen-space pipeline 406 operations for geometry that overlaps the associated fine subdivisions 702.

During execution of fine binning operations (the fine binning pass) in a rendering engine 402, the primitives are provided to the world-space pipeline 404 in an order determined by the coarse binner 410. After processing in the world-space pipeline 404, the fine binner 412 reorders those primitives in fine-binning tile order (that is, in the order of the fine binning tiles 502). In other words, the fine binner 412 “replays” or feeds primitives to the screen-space pipeline 406 in the order of the fine binning tiles 502. For example, the fine binner 412 stores primitives into the fine binning buffer 416 and, subsequently, sends the primitives from that buffer 416 that overlap one fine binning tile 502 to the screen space pipeline 406, and then the primitives from that buffer 416 that overlap another fine binning tile 502 to the screen space pipeline 406, and so on.

In the above descriptions, two types of tiles are described: binning tiles (502 and 504) and subdivision tiles (702 and 704). The binning tiles are the tiles that determine how a rendering engine 502 reorders work for processing. The subdivision tiles are the tiles that indicate how the geometry is divided for processing between the parallel rendering engine 402.

It is possible for fine binning tiles 502 to have the same or different size as the fine subdivisions 702, and for the coarse binning tiles 504 to have the same or different size as the coarse subdivisions 704. However, benefit is gained in the situation where the size of the subdivisions for parallel processing for coarse binning operations is the same as the size of the coarse tiles used for coarse binning. In such instances, each rendering engine 402 is assigned a portion of the render target corresponding to a set of coarse bins. This is in contrast with a scheme in which the size of the parallel subdivisions between rendering engines 402 is different from the size of the coarse bins.

By utilizing the same size for the coarse tiles and the parallel subdivisions, the rendering engines 402 do not need to (and, in some implementations, do not) communicate relative API order of the primitives. More specifically, it is required that the rendering engines 402 render geometry according to “API” order, which is the order requested by the client of the rendering engines 402 (e.g., the CPU). If the sizes of the coarse tiles and the size of the parallel subdivision for coarse operations were different, then it could be possible for a rendering engine 402 to be placing primitives into the coarse buffer 414 for the same coarse tile as a different rendering engine 402. To maintain API order, these rendering engines 402 would have to communicate about relative order, which could be expensive in terms of processing resources and could also result in lower performance due to the overhead of communication required to synchronize processing between the two rendering engines 402. By having the coarse tiles and parallel subdivision be the same size, no such communication needs to occur.

FIG. 8 is a flow diagram of a method 800 for performing rendering operations, according to an example. Although described with respect to the system of FIGS. 1-7, those of skill in the art will recognize that any system configured to perform the steps in any technically feasible order falls within the scope of the present disclosure.

At step 802, a first rendering engine 402 performs a coarse binning pass in parallel with a second rendering engine 402. Each rendering engine 402 utilizes a coarse binning tile size that is the same as a coarse subdivision 704 size, to generate coarse binning results.

As described elsewhere herein, the coarse binning tile size defines the size of the coarse binning tiles 504. The coarse binning tiles 504 define how the rendering engines 402 perform coarse binning. Specifically, the rendering engines 402 order geometry based on the coarse binning tiles 504 such that the rendering engines 402 perform subsequent operations (e.g., the fine binning pass) first for one coarse binning tile 504 then for another coarse binning tile 504, and so on. The coarse subdivision 704 size defines the size of the coarse subdivisions 704 that indicate how work is divided between rendering engines 402. As stated elsewhere herein, for a particular rendering engine 402, the “replay” of the coarse binning data for the fine binning pass occurs for geometry that overlaps the coarse subdivisions 704 associated with that rendering engine 402 and not for geometry that does not overlap such coarse subdivisions 704. The size of the coarse binning tiles 504 being the same as the size of the coarse subdivisions 704 means that only one rendering engine 402 determines which primitives overlap any particular coarse binning tile 504 in the coarse binning pass. Thus, a rendering engine 402 is able to write the primitives that overlap a coarse binning tile 504 into the coarse buffer 414 without communicating with another rendering engine 402.

At step 804, the first rendering engine 402 and second rendering engine 402 perform fine binning passes in parallel, based on the subdivision results. More specifically, each rendering engine 402 replays the coarse binned data in coarse bin order. In each rendering engine 402, the coarse binned data includes geometry that overlaps the coarse subdivisions assigned to that rendering engine 402 and does not include geometry that does not overlap the coarse subdivisions assigned to that rendering engine 402. This data is processed through the world-space pipeline 404 and the resulting screen-space geometry is provided to the fine binner 412. At the fine binner 412, each rendering engine 402 processes geometry assigned to the fine subdivisions 702 assigned to that rendering engine 402 and does not process geometry that does not overlap fine subdivisions 702 assigned to the rendering engine 402. The fine binner 412 orders the data based on the fine binning tiles 502, causing that data to be processed in order of fine binning tiles 502. For example, the fine binner 412 transmits to the screen space pipeline 406 geometry (e.g., all such geometry) from the fine binning buffer 416 that overlaps one fine binning tile 502, then transmits to the screen space pipeline 406 geometry (e.g., all such geometry) from the fine binning buffer 416 that overlaps another fine binning tile 502, and so on. The geometry transmitted by a rendering engine 402 in this manner is geometry that overlaps the fine subdivisions 702 assigned to that rendering engine 402 but does not include geometry that does not overlap such fine subdivisions 702.

Although a certain number of various elements are illustrated in the figures, such as two rendering engines 402, this disclosure contemplates implementations in which there are different numbers of such elements.

The various functional units illustrated in the figures and/or described herein (including, but not limited to, the processor 102, the input driver 112, the input devices 108, the output driver 114, the output devices 110, the APD 116, the APD scheduler 136, the graphics processing pipeline 134, the compute units 132, the SIMD units 138, each stage of the graphics processing pipeline 134 illustrated in FIG. 3, or the elements of the rendering engines 402, including the coarse buffer 414, fine binning buffer 416, two-level primitive batch binner 408, coarse binner 410, and fine binner 412, may be implemented as a general purpose computer, a processor, a processor core, or fixed function circuitry, as a program, software, or firmware, stored in a non-transitory computer readable medium or in another medium, executable by a general purpose computer, a processor, or a processor core, or as a combination of software executing on a processor or fixed function circuitry. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for rendering, comprising:
performing two-level primitive batch binning in parallel across multiple rendering engines, wherein tiles for subdividing coarse-level work across the rendering engines have the same size as tiles for performing coarse binning.

2. The method of claim 1, wherein the coarse-level work includes performing culling.

3. The method of claim 1, wherein the coarse binning includes organizing primitives by which coarse bin the primitives overlap.

4. The method of claim 1, wherein the two-level batch binning includes fine binning.

5. The method of claim 4, wherein the fine binning includes organizing primitives based on tiles at a finer level than the coarse binning.

6. The method of claim 5, wherein the organizing includes replaying primitives in order of which coarse tiles the primitives overlap.

7. The method of claim 4, wherein subdividing the coarse-level work occurs in a coarse binning pass and the fine binning is performed in a fine binning pass subsequent to the coarse binning pass.

8. The method of claim 1, wherein the tiles for subdividing coarse-level work across the rendering engines specify which portions of a render target are assigned to which rendering engines.

9. The method of claim 1, wherein the tiles for performing coarse binning specify an order of processing in a coarse binning pass.

10. A system for rendering, comprising:
a first rendering engine; and
a second rendering engine,
wherein the first rendering engine and the second rendering engine are configured to perform two-level primitive batch binning in parallel, wherein tiles for subdividing coarse-level work across the rendering engines have the same size as tiles for performing coarse binning.

11. The system of claim 10, wherein the coarse-level work includes performing culling.

12. The system of claim 10, wherein the coarse binning includes organizing primitives by which coarse bin the primitives overlap.

13. The system of claim 10, wherein the two-level batch binning includes fine binning.

14. The system of claim 13, wherein the fine binning includes organizing primitives based on tiles at a finer level than the coarse binning.

15. The system of claim 14, wherein the organizing includes replaying primitives in order of which coarse tiles the primitives overlap.

16. The system of claim 13, wherein subdividing the coarse-level work occurs in a coarse binning pass and the fine binning is performed in a fine binning pass subsequent to the coarse binning pass.

17. The system of claim 10, wherein the tiles for subdividing coarse-level work across the rendering engines specify which portions of a render target are assigned to which rendering engines.

18. The system of claim 10, wherein the tiles for performing coarse binning specify an order of processing in a coarse binning pass.

19. A method for rendering, the method comprising:
at a first rendering engine, performing two-level primitive batch binning; and
at a second rendering engine, performing two-level primitive batch binning in parallel with the first rendering engine,
wherein the two-level primitive batch binning includes performing a coarse binning pass and a fine binning pass, wherein the coarse binning pass includes reordering work based on coarse binning tiles, wherein work is divided between the first rendering engine and the second engine based on coarse subdivisions that are the same size as the coarse binning tiles.

20. The method of claim 19, wherein the coarse-level work includes performing culling.
